(19) United States
(12) Patent Application Publication
(10) Pub. No.: US 2024/0430797 A1
(43) Pub. Date: Dec. 26, 2024

(54) SYSTEMS AND METHODS FOR IMPLEMENTING SLEEPY FUNCTIONALITY IN WIRELESS MESH NETWORKS

(71) Applicant: Apple Inc., Cupertino, CA (US)

(72) Inventors: Arun Vijayakumari Mahasenan, Fremont, CA (US); Venkateswara Rao Manepalli, San Jose, CA (US)

(21) Appl. No.: 18/339,764

(22) Filed: Jun. 22, 2023

(51) Int. Cl. H04W 52/02; H04W 72/0446

(52) U.S. Cl. CPC H04W 52/0216; H04W 72/0446; H04W 84/18

(57) ABSTRACT

The present disclosure relates to techniques for wireless communication between electronic devices in a wireless network, such as a mesh wireless network. For example, a first electronic device may include processing circuitry that is configured to cause a transceiver of the first electronic device to transmit to a second electronic device in a wireless network an indication of time slots. The processing circuitry may cause at least a portion of the transceiver to enter a low power state during one or more times outside the time slots and cause the transceiver to exit the low power state to transmit or receive wireless signals during the time slots.

### BACKGROUND

The present disclosure relates generally to wireless communication, and more specifically to the operation of transmitters and receivers in wireless communication devices associated with wireless communication.

In an electronic device, a transmitter and a receiver may each be coupled to an antenna to enable the electronic device to both transmit and receive wireless signals. Electronic devices may communicate wirelessly in several types of networks and in accordance with several standards. One such type of network is a low-rate wireless personal area network (LR-WPANs), whose operation is defined in Institute of Electrical and Electronics Engineers (IEEE) Standard 802.15.4 (also known as “IEEE Standard for Low-Rate Wireless Networks”). IEEE Standard 802.15.4 provides the basis for several networking specifications, such as Zigbee, WirelessHART, 6LoWPAN, Thread, and SNAP.

One of the features of some IEEE Standard 802.15.4 networks, such as Thread networks, is the classification of nodes of a network (e.g., electronic devices connected to the network) as being a router or an end device. In such networks, transceivers of routers and some types of end devices may constantly be enabled. For example, in the context of a router, the router's transceiver may constantly be enabled to be able to provide secure commissioning services for devices attempting to join the network as well as to receive and forward data packets. The transceiver of some end devices may be constantly enabled to receive or transmit data to one or more routers. However, by constantly being enabled, the transceivers of electronic devices (and the electronic devices themselves) may utilize an undesirable amount of electrical power available on a power source (e.g., a battery) of the electronic device. Additionally, network traffic may be undesirably high, which may cause wireless coexistence issues or impede performance and/or bandwidth in a wireless network.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a first electronic device includes a transceiver and processing circuitry operatively coupled to the transceiver. The processing circuitry is configured to cause the transceiver to transmit an indication of a first plurality of time slots and a second plurality of time slots to a second electronic device that is communicatively coupled to the first electronic device via a wireless network. The processing circuitry is also configured to cause at least a portion of the transceiver to enter a low power state during one or more times outside of the first plurality of time slots and the second plurality of time slots. Additionally, the processing circuitry is configured to cause the transceiver to exit the low power state to transmit or receive wireless signals during the first plurality of time slots or the second plurality of time slots.

In another embodiment, a non-transitory computer-readable medium includes instructions that, when executed by processing circuitry of a first electronic device, cause the processing circuitry to cause a transceiver of the first electronic device to transmit an indication of a first plurality of time slots and a second plurality of time slots to a second electronic device that is communicatively coupled to the first electronic device via a wireless network. When executed, the instructions also cause the processing circuitry to cause at least a portion of the transceiver to enter a low power state during one or more times outside of the first plurality of time slots and the second plurality of time slots. Furthermore, when executed, the instructions cause the processing circuitry to cause the transceiver to exit the low power state to transmit or receive wireless signals during the first plurality of time slots or the second plurality of time slots.

In yet another embodiment, a system includes a first electronic device that includes a first transceiver. The system also includes a second electronic device that includes a second transceiver communicatively coupled to the first transceiver via a wireless mesh network. The second electronic device also includes processing circuitry operatively coupled to the second transceiver. The processing circuitry is configured to cause the second transceiver to transmit an indication of a first plurality of time slots and a second plurality of time slots to the first transceiver. The first plurality of time slots is associated with the second transceiver receiving wireless signals transmitted by the first transceiver. The second plurality of time slots is associated with the second transceiver transmitting wireless signals to the second electronic device. The processing circuitry is also configured to cause at least a portion of the second transceiver to enter a low power state during one or more times outside of the first plurality of time slots and the second plurality of time slots. Additionally, the processing circuitry is configured to cause the second transceiver to exit the low power state to transmit or receive wireless signals during the first plurality of time slots or the second plurality of time slots.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of an IEEE Standard 802.15.4-based Thread network that may include the electronic device of FIG. 1 as a node, according to embodiments of the present disclosure;

FIG. 4 is a schematic diagram of another IEEE Standard 802.15.4-based Thread network that may include the electronic device of FIG. 1 as a node, according to embodiments of the present disclosure;

FIG. 5 is a flow diagram of a process for communicating wirelessly, such as between electronic devices with sleepy functionality, according to embodiments of the present disclosure;

FIG. 6 is a timing diagram illustrating operations of the process of FIG. 5, according to embodiments of the present disclosure;

FIG. 7 is a timing diagram illustrating time slots during which two electronic devices may transmit or receive wireless signals, according to embodiments of the present disclosure; and

FIG. 8 is a timing diagram illustrating time slots during which three electronic devices may transmit or receive wireless signals, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately.” “near,” “about.” “close to.” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

The present disclosure relates to techniques for coordinating communication between electronic devices connected to wireless networks, such as IEEE Standard 802.15.4 networks. One of the features of some IEEE Standard 802.15.4 networks, such as Thread networks, is the classification of nodes of a network (e.g., electronic devices connected to the network) as being a router or an end device. In such networks, transceivers of routers and some types of end devices may constantly be enabled. For example, in the context of a router, the router's transceiver may constantly be enabled to be able to provide secure commissioning services for devices attempting to join the network as well as to receive and forward data packets. The transceiver of some end devices may be constantly enabled to receive or transmit data to one or more routers. However, by constantly being enabled, the transceivers of electronic devices (and the electronic devices themselves) may utilize an undesirable amount of electrical power available on a power source (e.g., a battery) of the electronic device. Additionally, network traffic may be undesirably high, which may cause wireless coexistence issues or impede performance and/or bandwidth in a wireless network.

To reduce network usage and power consumption of electronic device, communication between electronic devices of a wireless network can be coordinated to occur during particular (e.g., determined) time slots. For example, one device may determine time slots at which communication (e.g., transmitting or receiving wireless signals) may occur and send an indication of the time slots to one or more other devices. Outside of the time slots, the electronic devices or components thereof (e.g., transceivers, radios) may enter or be in a low power state. The electronic devices may exit the low power state so that the electronic devices can communicate with one another during the time slots. This type of operation in which devices may be in a low power state outside of designated time slots may be referred to as “sleepy functionality.” By implementing sleepy functionality on electronic devices in a wireless network, network usage in the wireless network may be reduced, and power consumption by electronic devices in the wireless network may also be reduced.

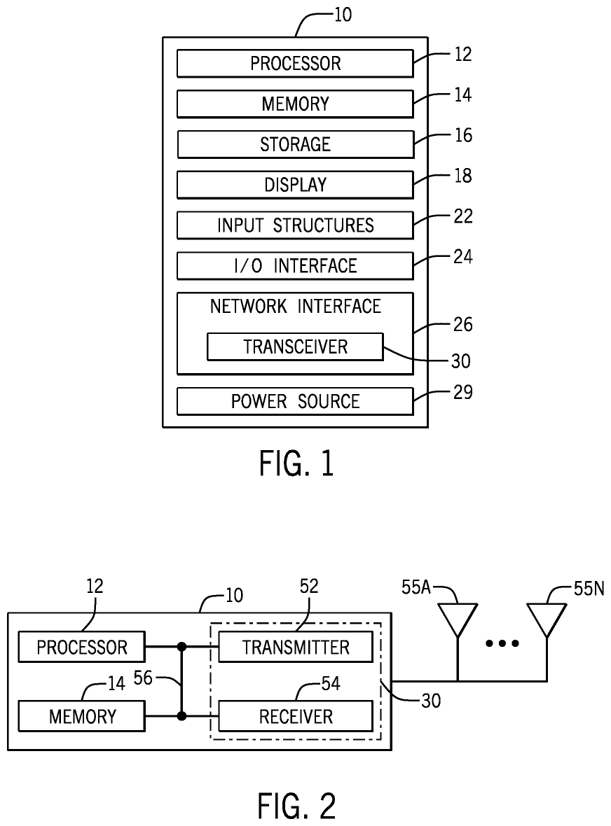

Keeping the foregoing in mind, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, a smart speaker, home automation equipment (including, but not limited to switches, outlets, controllers, remote controls, irrigation or sprinkler system equipment, sensors, lights, thermostats), wireless (or wired) routers, network extenders, or power equipment (e.g., controllers, power storage devices, solar panels), a smart appliance (e.g., refrigerator, dishwasher, washer, dryer, etc.), a smart door lock, smart blinds, smart curtains, and other similar devices. In additional or alternative embodiments, the electronic device 10 may include an access point, such as a base station, a router (e.g., a wireless or Wi-Fi router), a hub, a switch, and so on. The electronic device 10 may also be any Thread-enabled router, device, or accessory capable of transmitting or receiving a beacon or a beacon request. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as a LR-WPAN or an ultra-wideband (UWB) or a BLUETOOTH® network, a local area network (LAN) or wireless local area network (WLAN), such as a network employing one of IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a satellite network, a non-terrestrial network, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive data between one another.

The electronic device 10 may include the transmitter 52 and/or the receiver 54 that respectively enable transmission and reception of data between the electronic device 10 and an external device via, for example, a network (e.g., including base stations) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

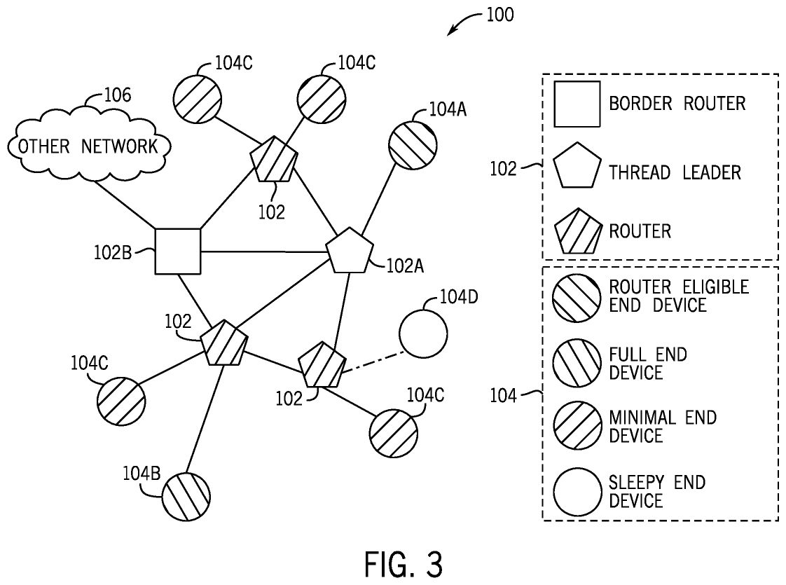

FIG. 3 is a schematic diagram of a wireless network 100 in which the electronic device 10 may be connected. In particular, the wireless network 100 is a LR-WPAN, and, even more particularly, a Thread network. While the techniques described herein may be described with respect to the Thread network, it should be noted that the techniques may be utilized with other types of wireless networks, including, but not necessarily limited to, any IEEE Standard 802.15.4 network. For example, the techniques of the present disclosure may be utilized in wireless mesh networks, which generally refers to wireless networks that utilize a mesh topology. For instance, wireless mesh networks may follow a WLAN topology in which the nodes (e.g., devices connected to the mesh network) connect directly, dynamically, and non-hierarchically to other nodes (e.g., as many nodes as possible) and cooperate with one another to route data to and from devices. Wireless mesh networks include, but are not limited to, IEEE Standard 802.15.4 networks.

The wireless network 100 includes several nodes (e.g., routers 102 and end devices 104) that are connected to one another as illustrated in FIG. 3. Each of the nodes is an electronic device included in the wireless network 100. As illustrated, there are several types of nodes in the wireless network 100. Depending on the capabilities of the electronic device 10, the electronic device 10 may be one or more of any of the types of nodes. The particular types of nodes included in the wireless network 100 include routers 102 (collectively referring to routers 102 (e.g., routers that are not further classified as discussed below), thread leader 102A, and border router 102B) and end devices 104 (collectively referring to end devices 104A, 104B, 104C, 104D). Routers 102 are nodes that forward packets for network devices, provide secure commissioning services for devices attempting to join the wireless network 100, and keep their transceiver(s) enabled at all times. End devices 104 are nodes that do not forward packets for other network devices, communicate (primarily) with a single router 102, and may disable their transceiver(s) to reduce power. As discussed below, routers 102 and some end devices 104 may also be classified as full Thread devices, while other end devices may be classified as minimal Thread devices. A full Thread device may always have its radio on, maintain IPv6 address mappings, and subscribe to an all-routers multicast address. Minimal Thread devices may not subscribe to the all-routers multicast address and forward their messages to a router 102 (or an end device 104 that is functioning as a router 102).

Within the classification of routers 102, there may be several types of routers 102. For example, a router 102 may be a thread leader 102A, which manages the other routers in the wireless network 100. A router 102 may also be a border router 102B, which is a device that can forward data to another network 106, such as a network other than a Thread network (e.g., a Wi-Fi® network). Routers 102 are full Thread devices.

Within the classification of end devices 104, there are router eligible end devices 104A, full end devices 104B, minimal end devices 104C, and sleepy end devices 104D. Router eligible end devices 104A and full end devices 104B are full Thread devices. More specifically, router eligible end devices 104A are end devices 104 that can be promoted to function as a router 102, while full end devices 104B are end devices 104 that are full Thread devices but cannot be promoted to be a router 102. Minimal end devices 104C and sleepy end devices 104D are minimal Thread devices. In particular, a minimal end device 104C does not need to poll for messages sent from the router 102 to which the minimal end device 104C is connected, and the minimal end device's 104C transceiver is always on. A sleepy end device 104D is an end device 104 that is typically in sleep and wakes up occasionally to poll for messages from the router 102 to which it is connected.

The wireless network 100 may be implemented indoors (e.g., within a dwelling or office space), outdoors, or both. The nodes may include electrical devices including, but not limited to, the electronic devices listed above that the electronic device 10 may be. For instance, the nodes (which include the electronic device 10) may be a phone, tablet, computer, a portable electronic or handheld electronic, a wearable electronic device, a smart speaker, home automation equipment (including, but not limited to switches, outlets, controllers, irrigation or sprinkler system equipment, sensors, lights, thermostats), wireless routers, network extenders, or power equipment), a smart appliance (e.g., refrigerator, dishwasher, washer, dryer, etc.), a smart door lock, or any combination thereof. The nodes may be any Thread-enabled router, device, or accessory capable of transmitting or receiving a beacon or a beacon request.

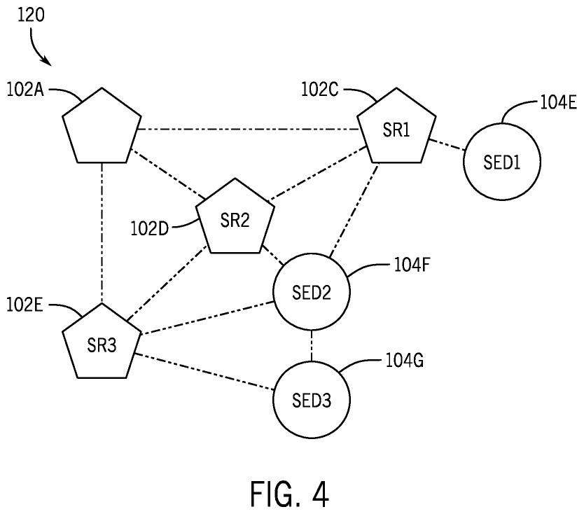

The present disclosure relates to techniques to enable sleepy router functionality as well as communication between sleepy routers (e.g., between two or more sleepy routers) and end devices (e.g., communication between one or more (sleepy) routers and one or more (sleepy) end devices). As noted above, in the context of Thread networks, routers are full Thread devices and therefore may always have their radios on. By enabling sleepy functionality for routers, the radios of routers may be turned off, for example, when not in use (e.g., when transmitting or receiving). The radios of router may be turned on during frames of time in which communication is to or may occur. Indeed, as discussed herein, the frames or blocks of time in which communication can occur may be scheduled. Accordingly, enabling sleepy functionality of routers in wireless networks (e.g., IEEE Standard 802.15.4 networks) may reduce power consumption by electronic devices as well as network traffic in the wireless networks. Bearing this in mind. FIG. 4 is a schematic diagram of a wireless network 120 that may include the electronic device 10. In particular, the wireless network 120 may include a LR-WPAN, and, even more particularly, a Thread network. While the techniques described herein may be described with respect to the Thread network, it should be noted that the techniques may be utilized with other types of wireless networks, including, but not necessarily limited to, wireless mesh networks and any IEEE Standard 802.15.4 network.

Similar to the wireless network 100, the wireless network 120 includes several nodes that are connected to one another as illustrated FIG. 4. In particular, the nodes include thread leader 102A, sleepy routers 102 (collectively referring to sleepy router 102C, sleepy router 102D, and sleepy router 102E), and end devices 104 (collectively referring to end device 104E, end device 104F, and end device 104G), which may be sleepy end devices or any of the other types of end devices discussed above, including router eligible end devices. The electronic device 10 may be one of the sleepy routers 102 or one of the end devices 104. As discussed below, communication between the sleepy routers 102 and end devices 104 may be coordinated (e.g., scheduled) to enable the sleepy routers 102 and end devices 104 to sleep (e.g., be in a low power state) outside of the coordinated times (e.g., time slots). The techniques described herein may be utilized for communication between one sleepy router (e.g., one or more sleepy routers 102) and one or more other sleepy routers, one or more end devices 104, or both one or more other sleepy routers and one or more end devices 104. Additionally, the techniques described herein may be utilized for communication between an end device (e.g., one of the end devices 104) and one or more sleepy routers 102, one or more other end devices 104, or both one or more other sleepy routers 102 and one or more other end devices 104. It should be noted that these techniques may be utilized with any type of router or end device. Thus, sleepy router functionality may be utilized with any of the routers or end devices described above with respect to FIG. 3.

However, before continuing to discuss coordinated communication, it should be noted that the wireless network 120 may be implemented indoors (e.g., within a dwelling or office space), outdoors, or both. The nodes (e.g., thread leader 102A, sleep routers 102, and end devices 104) may include electrical devices including, but not limited to, the electronic devices listed above that the electronic device 10 may be. For instance, the nodes (which include the electronic device 10) may be a phone, tablet, computer, a portable electronic or handheld electronic, a wearable electronic device, a smart speaker, home automation equipment (including, but not limited to switches, outlets, controllers, remote controls, irrigation or sprinkler system equipment, sensors, lights, thermostats), wireless (or wired) routers, network extenders, or power equipment (e.g., controllers, power storage devices, solar panels), a smart appliance (e.g., refrigerator, dishwasher, washer, dryer, etc.), a smart door lock, smart blinds, smart curtains, and other similar devices. The nodes may be any Thread-enabled router, device, or accessory.

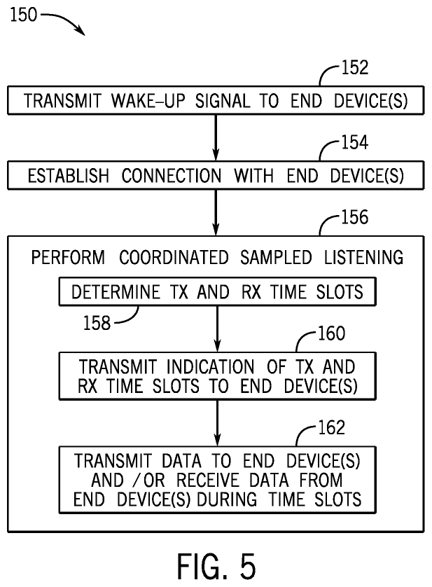

FIG. 5 is a flow diagram of a process 150 for communicating wirelessly. The process 150 may be performed by the electronic device 10 or a node of a wireless network, such as one or more of the sleepy routers 102 or end devices 104 of the wireless network 120. Accordingly, the process 150 may be performed to enable communication between devices with sleepy functionality. Indeed, any suitable device (e.g., a controller) that may control components of the electronic device 10, such as the processor 12 or the transceiver 30, may perform the process 150. In some embodiments, the process 150 may be implemented by executing instructions stored in a tangible, non-transitory, computer-readable medium, such as the memory 14 or storage 16, using the processor 12 or transceiver 30. For example, the process 150 may be performed at least in part by one or more software components, such as an operating system of the electronic device 10, one or more software applications of the electronic device 10, and the like. While the process 150 is described using steps in a specific sequence, it should be understood that the present disclosure contemplates that the described steps may be performed in different sequences than the sequence illustrated, and certain described steps may be skipped or not performed altogether. Furthermore, while the process 150 is discussed below in the context of sleepy router communicating with one or more end devices, it should be noted that the process 150 may be performed for communication between a sleepy router and one or more (sleepy) routers, one or more end devices, or both one or more sleepy routers and one or more end devices. The process 150 may also be performed for communication between two or more end devices. The process 150 generally includes transmitting a wake-up signal to one or more end devices (process block 152), establishing a connection with the one or more end devices (process block 154), and performing coordinated sampled listening (process block 156). Performing coordinated sampled listening may include determining transmission and reception time slots (process sub-block 158), transmitting an indication of the transmission and reception time slots to the one or more end devices (process sub-block 160), and transmitting data to the one or more end devices and/or receiving data from the one or more end devices during the time slots.

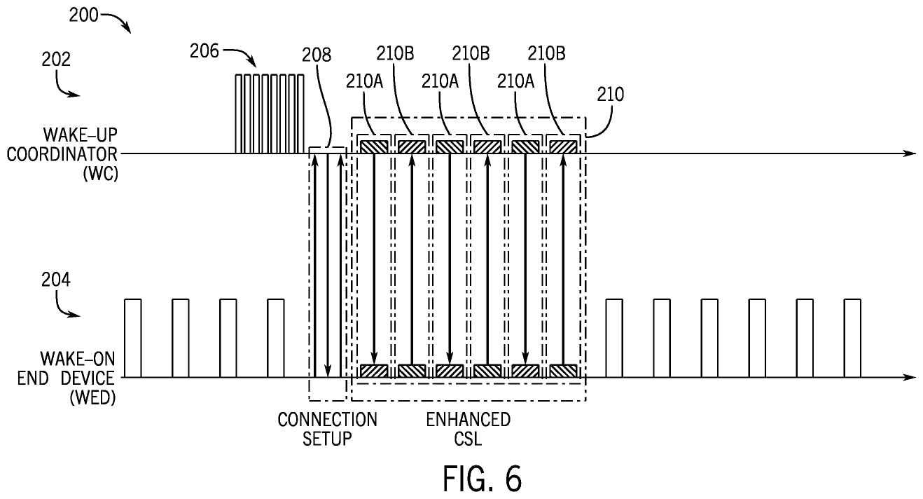

In process block 152, the processor 12 may transmit one or more wake-up signals (e.g., via the transceiver 30) to one or more devices. The wake-up signals may include explicit in-band wake-up signals or out-of-band signals such as, like proximity signals, touch signals, UWB signals, etc. In the context of FIG. 4 and the wireless network 120, the sleepy router 102C may transmit one or more wake-up signals to one or more end devices, such as the end device 104E and/or the end device 104F. To help elaborate, FIG. 6 is a timing diagram 200 corresponding to operations of the process 150. A first portion 202 of the timing diagram 200 corresponds to operations performed by a first node (which may be called a “wake-up coordinator” (WC)), such as a sleepy router (e.g., sleepy router 102C). A second portion of the timing diagram 204 corresponds to operations performed by a second node, (which may be referred to as a “wake-on end device” (WED)). As a non-limiting example, may be the end device 104E. As illustrated in the first portion 202, the first node may transmit one or more wake-up signals during a wake-up sequence 206. The wake-up sequence 206 may be performed, for example, as provided by an IEEE Standard 802.15.4 specification, such as Thread, Zigbee, WirelessHART, 6LoWPAN, or SNAP. Before returning to discuss the process 150 in more detail, it should be noted that the second device may “wake up” upon receiving the wake-up signals. In other words, the device or node receiving the wake-up signals may be in a low power state (e.g., a sleep mode or other low power state, such as a state in which a transceiver of the device or node is off or in a low power state) and, in response to receiving the wake-up signals, exit the low power state and enter a full power state (e.g., a power mode in which the transceiver of the device or node can transmit and/or receive wireless signals).

Returning to FIG. 5 and continuing the discussion of the process 150, in process block 154, the processor 12 may establish (e.g., via the transceiver 30) a connection with the one or more end devices. The connection between the processor 12 and the one or more end devices may be established for example, as provided by a IEEE Standard 802.15.4 specification, such as Thread, Zigbee, WirelessHART, 6LoWPAN, or SNAP. For instance, in the context of the network 120 being a Thread network, a connection between the sleepy router 102C and the end device 104E and/or the end device 104F may be established in accordance with the Thread specification. Referring briefly to FIG. 6, during a connection period 208, a connection may be established between the wake-up coordinator and the wake-on end device. During the connection period 208, the wake-on end device may acknowledge receipt of the wake-up signals or otherwise transmit one or more wireless signals indicating that the wake-on end device has exited a low power state. The wake-up coordinator and wake-on end device may transmit and receive other data (e.g., as provided for in the Thread specification) to establish a connection.

Returning to FIG. 5 and the discussion of the process 150, in process block 156, the processor 12 may perform (e.g., via the transceiver 30) coordinated sampled listening (CSL). To perform coordinated sampled listening, the processor 12 may perform several operations. For example, in sub-process block 158, the processor 12 may determine transmission and reception time slots during which the transceiver 30 is to transmit and receive wireless signals (or be configured to transmit and receive wireless signals). The processor 12 may dynamically determine the time slots based on current radio conditions, such as, but not limited to, traffic on the wireless network 120 and/or traffic on one or more other networks (e.g., a WiFi network, a Bluetooth network, another IEEE 802.11x network, another IEEE Standard 802.15.4 network, or a combination thereof) via which the electronic device 10 may communicate using the transceiver 30. That is, the network traffic may include or be indicative of use of the transceiver 30 (and/or the transceiver of another electronic device to which a connection has been established). Accordingly, the processor 12 may determine the time slots based on the availability of the transceiver 30 as well as the availability of one or more other transceivers (of other electronic devices) to dynamically allocate distributed time slots to be utilized for wireless communication. The time slots during which the transceiver 30 is to be configured to transmit are time slots in which the one or more end devices (or transceivers thereof) may be configured to receive wireless signals. The time slots during which the transceiver 30 is to be configured to receive are time slots in which the one or more end devices (or transceivers thereof) may be configured to receive wireless signals. Returning briefly to the example in which the process 150 is being performed by the sleepy router 102C, to help provide more context, the sleepy router 102C may determine time slots during which the transceiver 30 of the sleepy router 102C may transmit wireless signals to the end device 104E, the end device 104F, or both the end device 104E and the end device 104F. Additionally, the sleepy router 102C may determine time slots during which the transceiver 30 of the sleepy router 102C may receive wireless signals transmitted by the end device 104E, the end device 104F, or both the end device 104E and the end device 104F.

When determining time slots, a duration for each time slot may be determined, and an interval between time slots may also be determined. Accordingly, time slots may occur at each determined interval for each determined duration. For example, referring now to FIG. 6, the time slots determined at sub-process block 158 may be time slots 210 of the timing diagram 200. The time slots 210 include time slots 210A and time slots 210B. The time slots 210A may be time periods of time during which the transceiver 30 of the wake-up coordinator (e.g., electronic device 10 or another device or node that performs sub-process block 158), is configured to transmit data to other devices, while the time slots 210B may be periods of time during which the transceiver 30 of the wake-up coordinator is configured to receive data from other devices. As such, transceivers of the other devices may be configured to receive data during the time slots 210 and to transmit data during the time slots 210B.

Returning to FIG. 5 and the discussion of the process 150, in sub-process block 160, the processor 12 may transmit (e.g., via the transceiver 30) an indication of the transmission and reception time slots to the one or more end devices. In other words, in sub-process block 160, the electronic device 10 (or device that determines the time slots in process sub-block 158) may transmit an indication of the determined time slots to other device(s) or node(s) in a wireless network. For example, in the context of the wireless network 120 of FIG. 4, the sleepy router 102C may transmit an indication (e.g., in data or wireless signals) indicative of the time slots. For example, the indication may indicate the time slots 210 of FIG. 6. As such, some of the time slots in the indication sent at sub-process block 160 may be associated with a first device transmitting data and another device or other devices receiving data. Additionally, some of the time slots in the indication may be associated with the other device(s) transmitting data and the first device receiving the data. The indication transmitted in sub-process block 160 may include or be indicative of an interval between time slots and/or a duration of the time slots.

Referring to FIG. 5, at sub-process block 162, the processor 12 may transmit data (e.g., via the transceiver 30) to the one or more end devices and/or receive data (e.g., via the transceiver 30) from the one or more end devices during the time slots (e.g., time slots 210). In other words, after the time slots 210 have been determined and an indication of the time slots 210 has been provided to one or more other devices, communication may occur during the time slots 210. More specifically, referring to FIG. 6, a first node of a wireless network (e.g., a wake-up coordinator, which may be sleepy router 102C) may transmit data during time slots 210A, while another node (or nodes) of the wireless network (e.g., end device 104E and/or end device 104F) may receive data transmitted by the first node during the time slots 210A. Conversely, the other node(s) may transmit data during the time slots 210B, and the first node may receive the data during the time slots 210B. In other words, the transceivers 30 of nodes (which may include the electronic device 10) in the wireless network 120 may be configured either to transmit or receive during particular time slots.

When a transceiver 30 or electronic device 10 is not configured to transmit or receive data, the processor 12 may cause the transceiver 30 or electronic device 10 to enter a low power state, and the processor 12 may cause the transceiver 30 or electronic device 10 to exit the low power state to transmit or receive data at a later time (e.g., during one of the time slots 210). In this manner, sleepy functionality may be implemented on routers and end devices wireless networks (e.g., Thread networks), even for routers and end devices whose transceivers or radios may otherwise (e.g., as called for or defined by the Thread specification) constantly be on (or otherwise not in a low power state). In other words, outside of the time slots (e.g., time slots 210), the transceiver 30 or electronic device 10 may enter a low power mode or state, and the transceiver or electronic device 10 may exit the low power state to transmit or receive data at a later time, such as during one of the time slots 210. As such, power consumed by the electronic device 10 as well as network traffic in the wireless network 120 may be reduced.

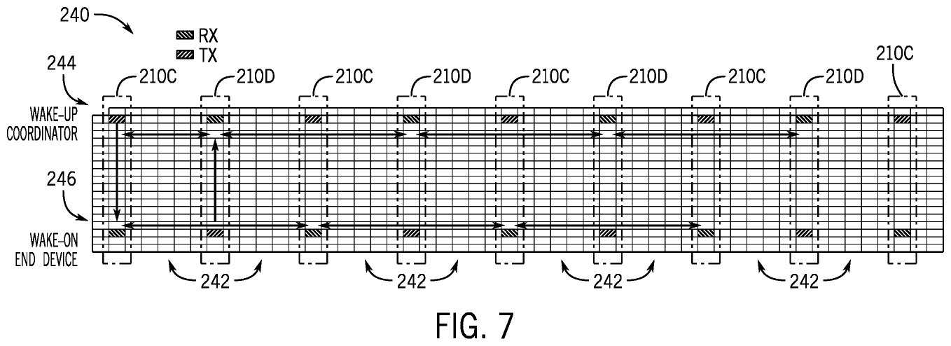

FIG. 7 is another timing diagram 240 illustrating time slots 210 (collectively referring to time slots 210C and time slots 210D) as well as intervals 242 between the time slots 210. During the time slots 210C, the transceiver 30 of a first device (represented by a first portion 244 of the timing diagram 240) may be configured to transmit data to a second device (represented by a second portion 246 of the timing diagram 240). During the time slots 210, the transceiver of the second device may also be configured to receive data, such as the data transmitted by the first device. After each or any of the time slots 210C ends (e.g., during one or more of the intervals 242), the transceiver 30 may (e.g., as caused by the processor 12) enter a low power state during which the transceiver 30 is not configured to transmit or receive data. Prior to or during a subsequent time slot, such as one of the time slots 210D, the transceiver 30 may exit the low power state so that during the time slots 210D, the transceiver 30 of the second device is configured to transmit data, and the transceiver 30 of the first device is configured to receive data (e.g., data transmitted by the second device). Somewhat similarly, after each or any of the time slots 210D ends (e.g., during one or more of the intervals 242), the transceiver 30 may (e.g., as caused by the processor 12) enter a low power state during which the transceiver 30 is not configured to transmit or receive data. Prior to or during a subsequent time slot, such as one of the time slots 210C, the transceiver 30 may exit the low power state so that during the time slots 210C, the transceiver 30 of the first device is configured to transmit data, and the transceiver 30 of the second device is configured to receive data. Accordingly, communication between electronic devices may be coordinated to occur during the time slots 210, thereby enabling the transceivers (or radio) or the electronic devices themselves to enter a low power state (while ensuring that there will be no missed communications between the devices).

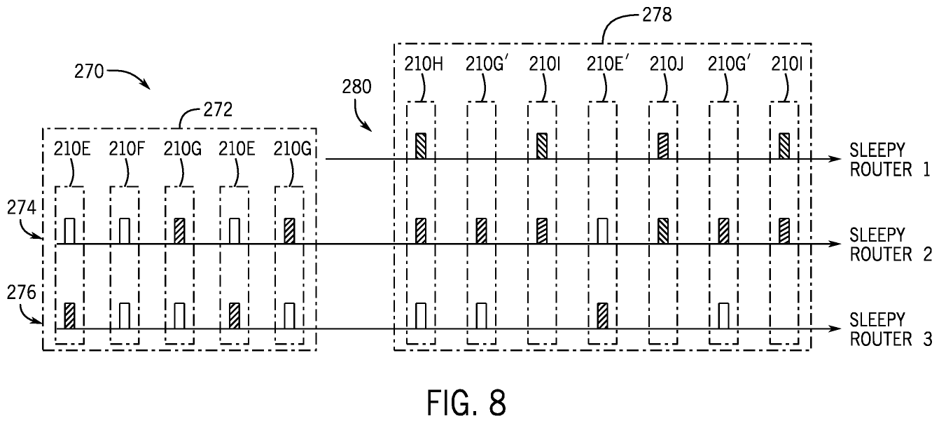

As noted above, the techniques of the present disclosure may be utilized for communication between more than two devices. Bearing this in mind, FIG. 8 is a timing diagram 270 depicting communication between three devices during time slots 210 (collectively referring to time slots 210E, time slot 210E′, time slot 210F, time slots 210G, time slots 210G′, time slot 210H, time slots 2101, and time slot 210J). More specifically, the timing diagram 270 is indicative of a first period of time 272 in which a first electronic device (represented by a first portion 274 of the timing diagram 270) and a second electronic device (represented by a second portion 276 of the timing diagram 270) may communicate. The timing diagram 270 is also indicative of a second period of time 278 during which the first electronic device may communicate with either or both of the second electronic device or a third electronic device (represented by a third portion 280 of the timing diagram 270). In this context, the first electronic device, the second electronic device, and the third electronic device may include one or more routers and/or one or more end devices. For example, referring briefly to FIG. 4, in one embodiment, the first electronic device, the second electronic device, and the third electronic device may be sleepy routers 102. More specifically, the first electronic device may be sleep router 102D, the second electronic device may be sleepy router 102E, and the third electronic device may be sleepy router 102C. In another embodiment, the first electronic device, the second electronic device, and the third electronic device may include one or more of the end devices 104. For example, the first electronic device may be the sleepy router 102D, the second electronic device may be another of the sleepy routers (e.g., sleepy router 102C or sleepy router 102E) or end device 104F, and the third electronic device may be a different device than the second electronic device selected from sleepy router 102C, sleepy router 102E, and the end device 104F. As another example, the first electronic device may be the sleepy router 102C, the second electronic device may be the sleepy router 102D, the end device 104E, or the end device 104F, and the third electronic device may be the sleepy router 102D, the end device 104E, or the end device 104F (with the second electronic device and the third electronic device being difference devices). Accordingly, while FIG. 8 may be discussed below in the context of the first electronic device, the second electronic device, and the third electronic device being (sleepy) routers, it should be understood that the timing diagram 270 may be applicable to communication among other combinations of devices (e.g., routers 102 and devices 104 of the wireless network 120). Accordingly, the techniques of the present application may be utilized to enable a router to communicate with another router, several other routers, an end device, several end devices, or any combination thereof. Moreover, the techniques of the present application may enable an end device to communicate with a router, several routers, another end device, several other end devices, or any combination thereof.

Referring back to FIG. 8, during the first period of time 272, the sleepy router 102D may communicate with the sleepy router 102E. For example, during the time slots 210E, the sleepy router 102D may receive wireless signals, and the sleepy router 102E may transmit wireless signals. During the time slot 210F, the sleepy router 102D and the sleepy router 102E may both receive wireless signals. During the time slots 210G, the sleepy router 102D may transmit wireless signals, and the sleepy router 102E may receive wireless signals. In another embodiment, during time slots 210E, the sleepy router 102D may transmit wireless signals, and the sleepy router 102E may receive wireless signals. During the time slot 210F, the sleepy router 102D and the sleepy router 102E may both receive wireless signals. During the time slots 210G, the sleepy router 102D may receive wireless signals, and the sleepy router 102E may transmit wireless signals.

During the second period of time 278, the sleepy router 102D may communicate with both the sleepy router 102 and the sleepy router 102C. In other words, during the second period of time 278, communication between one device (e.g., the sleepy router 102D) may be coordinated by the device. That is, the sleepy router 102D may perform (multiple iterations of) the process 150 to determine time slots during which the sleepy router 102D may communicate with the sleepy router 102E, the sleepy router 102C, or both the sleepy router 102E and the sleepy router 102C. For instance, during time slots 210E′ and time slots 210G′, communication between the sleepy router 102D and the sleepy router 102E may occur as discussed above with respect to time slots 210E and time slots 210G. During time slot 210H, the sleepy router 102D may transmit wireless signals, and the sleepy router 102C and the sleepy router 102E may receive wireless signals. Because the sleepy router 102D may communicate with both the sleepy router 102C and the sleepy router 102E during the time slot 210H, the time slot 210H may be representative of, or considered as, two time slots (e.g., a first time slot during which the sleepy router 102D and the sleepy router 102C communicate and a second time slot during which the sleepy router 102D and the sleepy router 102E communicate) that overlap. During time slots 2101, the sleepy router 102D may transmit wireless signals, and the sleepy router 102C may receive wireless signals. During time slot 210J the sleepy router 102D may receive wireless signals, and the sleepy router 102C may transmit wireless signals. In another embodiment, during time slot 210H, the sleepy router 102D may receive wireless signals, and the sleepy router 102C and the sleepy router 102E may transmit wireless signals. During time slots 2101, the sleepy router 102D may receive wireless signals, and the sleepy router 102C may transmit wireless signals. During time slot 210J the sleepy router 102D may transmit wireless signals, and the sleepy router 102C may receive wireless signals.

Furthermore, during times that are outside of the time slots 210, the sleepy router 102C, the sleepy router 102D, and the sleepy router 102E may enter a low power state. The sleepy router 102C, the sleepy router 102D, and the sleepy router 102E (or a portion thereof) may exit the low power state to communicate during the time slots 210. For example, sleepy router 102C and the sleepy router 102D may exit the low power state to communicate during time slots 2101 and time slot 210J, during which the sleepy router 102E may remain in the low power state.

By communicating in a coordinated manner (e.g., during particular time slots), electronic devices or transceivers or radios of electronic devices (e.g., electronic device 10) may enter a low power state, thereby reducing power consumed by the electronic device 10 as well as reducing network traffic on a wireless network. Indeed, as discussed above, the electronic device 10 or transceiver 30 may exit the power state to transmit or receive wireless signals during particular time slots, enter the low power state outside of the time slots, and again exit the low power state to transmit or receive wireless signals during subsequent time slots.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A first electronic device comprising:
a transceiver; and
processing circuitry operatively coupled to the transceiver and configured to:
cause the transceiver to transmit an indication of a first plurality of time slots and a second plurality of time slots to a second electronic device that is communicatively coupled to the first electronic device via a wireless network;
cause at least a portion of the transceiver to enter a low power state during one or more times outside of the first plurality of time slots and the second plurality of time slots; and
cause the transceiver to exit the low power state to transmit or receive wireless signals during the first plurality of time slots or the second plurality of time slots.

2. The first electronic device of claim 1, wherein:
the first plurality of time slots is associated with the transceiver receiving wireless signals from the second electronic device and the second plurality of time slots is associated with the transceiver transmitting wireless signals to the second electronic device; and
the processing circuitry is configured to cause the transceiver to transmit a second indication of a third plurality of time slots and a fourth plurality of time slots to a third electronic device that is communicatively coupled to the first electronic device via the wireless network, wherein the third plurality of time slots is associated with the transceiver receiving wireless signals from the third electronic device and the fourth plurality of times slots is associated with the transceiver transmitting wireless signals to the third electronic device.

3. The first electronic device of claim 2, wherein a first time slot of the first plurality of time slots overlaps with a second time slot of the third plurality of time slots.

4. The first electronic device of claim 2, wherein the first plurality of time slots and the third plurality of time slots are different.

5. The first electronic device of claim 2, wherein the processing circuitry is configured to:
cause the transceiver to transmit a multi-device wake-up command to the second electronic device and the third electronic device; and
after transmitting the multi-device wake-up command, cause the transceiver to transmit the indication and the second indication.

6. The first electronic device of claim 2, wherein the processing circuitry is configured to:
cause at least the portion of the transceiver to enter the low power state during one or more additional times outside of the first plurality of time slots and the third plurality of time slots; and
cause the transceiver to exit the low power state to receive wireless signals during the first plurality of time slots or the third plurality of time slots.

7. The first electronic device of claim 1, wherein the processing circuitry is configured to determine the first plurality of time slots and the second plurality of time slots based at least in part on network traffic on a second wireless network to which the first electronic device is communicatively coupled.

8. The first electronic device of claim 1, wherein the wireless network comprises a wireless mesh network.

9. The first electronic device of claim 1, wherein the wireless network comprises an Institute of Electrical and Electronics Engineers (IEEE) Standard 802.15.4 network.

10. The first electronic device of claim 1, wherein the wireless network comprises a Thread network.

11. The first electronic device of claim 10, wherein the second electronic device comprises a router of the Thread network.

12. The first electronic device of claim 1, wherein the second electronic device comprises a sleepy end device.

13. A non-transitory computer-readable medium comprising instructions that, when executed by processing circuitry of a first electronic device, cause the processing circuitry to:
cause a transceiver of the first electronic device to transmit an indication of a first plurality of time slots and a second plurality of time slots to a second electronic device that is communicatively coupled to the first electronic device via a wireless network;
cause at least a portion of the transceiver to enter a low power state during one or more times outside of the first plurality of time slots and the second plurality of time slots; and
cause the transceiver to exit the low power state to transmit or receive wireless signals during the first plurality of time slots or the second plurality of time slots.

14. The non-transitory computer-readable medium of claim 13, wherein the wireless network comprises a wireless mesh network.

15. The non-transitory computer-readable medium of claim 14, wherein the first electronic device comprises a router of the wireless mesh network.

16. The non-transitory computer-readable medium of claim 15, wherein the second electronic device comprises a second router of the wireless mesh network.

17. The non-transitory computer-readable medium of claim 15, wherein the second electronic device comprises an end device of the wireless mesh network.

18. A system, comprising:
a first electronic device comprising a first transceiver; and
a second electronic device comprising:
a second transceiver communicatively coupled to the first transceiver via a wireless mesh network; and
processing circuitry operatively coupled to the second transceiver and configured to:
cause the second transceiver to transmit an indication of a first plurality of time slots and a second plurality of time slots to the first transceiver, wherein the first plurality of time slots is associated with the second transceiver receiving wireless signals transmitted by the first transceiver and the second plurality of time slots is associated with the second transceiver transmitting wireless signals to the second electronic device:
cause at least a portion of the second transceiver to enter a low power state during one or more times outside of the first plurality of time slots and the second plurality of time slots; and
cause the second transceiver to exit the low power state to transmit or receive wireless signals during the first plurality of time slots or the second plurality of time slots.

19. The system of claim 18, wherein the first electronic device comprises second processing circuitry operatively coupled to the first transceiver and configured to:
cause at least a portion of the first transceiver to enter the low power state during the one or more times outside of the first plurality of time slots and the second plurality of time slots; and
cause the second transceiver to exit the low power state to:
transmit wireless signals during the first plurality of time slots; or
receive wireless signals during the second plurality of time slots.

20. The system of claim 19, wherein:
the first electronic device comprises a first router of the wireless mesh network; and
the second electronic device comprises a second router of the wireless mesh network or an end device of the wireless mesh network.
